(19) United States
(12) Patent Application Publication
(10) Pub. No.: US 2026/0051168 A1
(43) Pub. Date: Feb. 19, 2026

(54) EFFECT TREND IDENTIFICATION USING CREATION ATTRIBUTION

(71) Applicant: Google LLC, Mountain View, CA (US)

(72) Inventors: Yongzhe Wang, Cupertino, CA (US); Sourabh Prakash Bansod, Mountain View, CA (US)

(21) Appl. No.: 18/807,186

(22) Filed: Aug. 16, 2024

(51) Int. Cl. G06V 20/30; G06V 10/74; G06V 20/40

(52) U.S. Cl. CPC G06V 20/30; G06V 20/46; G06V 10/761; G06V 20/41

(57) ABSTRACT

In one example, a computing system comprises a memory that stores instructions, and processing circuitry that executes the instructions to: identify, from a plurality of media content items, a seed media content item with one or more effect attributes indicating one or more effects used in at least the seed media content item, determine whether the seed media content item is associated with a creation attribute indicating one or more users created one or more other media content items including the one or more effects within a predefined period of time after the seed media content item was watched by the one or more users, responsive to determining the seed media content item is associated with the creation attribute, identify a set of media content items with the one or more effect attributes, and output an indication of an effect trend including the set of media content items.

### BACKGROUND

Content sharing services, such as services that allow users to upload and share content (e.g., videos or images), may allow various users to apply various effects or filters to content. In some cases, a user may apply these effects to modify the appearance of their content, such as to allow the user to better express the user's artistic or editorial intent.

### SUMMARY

In general, various aspects of the techniques described in this disclosure are directed to effect trend identification using creation attribution. An effect trend may include a set of media content items (e.g., videos) that include the same effect attributes (e.g., video and audio effects). Some examples of video effects include bubble face effects, dance party effects, mirrored video effects, night vision effects, wavy video effects, and bloom effects that modify the appearance of a media content item. Video effects may also include video filters, such as color filters (e.g., black and white or color enhancement filters). Audio effects may include music (e.g., soundtracks), sound effects, background noise, and other audio that may be added to a media content item.

In accordance with the techniques disclosed herein, a computing system, such as of a content sharing service (e.g., video sharing service), may identify effect trends using creation attribution. For example, the computing system may determine a media content item, with particular video and audio effects, is associated with a creation attribute when the media content item inspires a user to create another media content item including the same particular video and audio effects. As will be described further below, the computing system may utilize the media content item with the creation attribute as seed content to identify other media content items within the effect trend. As such, the techniques disclosed herein allow identification of effect trends that are inspiring while also being coherent in that the media content items identified by the disclosed techniques may share at least some characteristics (e.g., video and audio effects and/or concepts). The computing device may present the effect trend to users, such as in the form of a content feed.

In one example, various aspects of the techniques are directed to a method comprising: identifying, by a computing system and from a plurality of media content items, a seed media content item with one or more effect attributes indicating one or more effects used in at least the seed media content item, determining, by the computing system, whether the seed media content item is associated with a creation attribute indicating one or more users created one or more other media content items including the one or more effects within a predefined period of time after the seed media content item was watched by the one or more users, responsive to determining the seed media content item is associated with the creation attribute, identifying, by the computing system, a set of media content items with the one or more effect attributes from the plurality of media content items, and outputting, by the computing system, an indication of an effect trend including the set of media content items.

In another example, various aspects of the techniques are directed to a computing system comprising: a memory that stores instructions, and processing circuitry that executes the instructions to: identify, from a plurality of media content items, a seed media content item with one or more effect attributes indicating one or more effects used in at least the seed media content item, determine whether the seed media content item is associated with a creation attribute indicating one or more users created one or more other media content items including the one or more effects within a predefined period of time after the seed media content item was watched by the one or more users, responsive to determining the seed media content item is associated with the creation attribute, identify a set of media content items with the one or more effect attributes from the plurality of media content items, and output an indication of an effect trend including the set of media content items.

In another example, various aspects of the techniques are directed to non-transitory computer-readable storage media comprising instructions, that when executed by processing circuitry, cause the processing circuitry to: identify, from a plurality of media content items, a seed media content item with one or more effect attributes indicating one or more effects used in at least the seed media content item, determine whether the seed media content item is associated with a creation attribute indicating one or more users created one or more other media content items including the one or more effects within a predefined period of time after the seed media content item was watched by the one or more users, responsive to determining the seed media content item is associated with the creation attribute, identify a set of media content items with the one or more effect attributes from the plurality of media content items, and output an indication of an effect trend including the set of media content items.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a conceptual diagram illustrating an example environment for effect trend identification using creation attribution, in accordance with one or more aspects of the present disclosure.

FIG. 2 is a block diagram illustrating an example environment for effect trend identification using creation attribution, in accordance with one or more aspects of the present disclosure.

FIG. 3A illustrates a first example of creation attribution information, in accordance with one or more aspects of the present disclosure.

FIG. 3B illustrates a second example of creation attribution information, in accordance with one or more aspects of the present disclosure.

FIG. 4 is a block diagram illustrating an example embedding space, in accordance with one or more aspects of the present disclosure.

FIG. 5 is a conceptual diagram illustrating an example computing device, in accordance with one or more aspects of the present disclosure.

FIG. 6 is a flowchart illustrating an example process for effect trend identification using creation attribution, in accordance with one or more aspects of the present disclosure.

### DETAILED DESCRIPTION

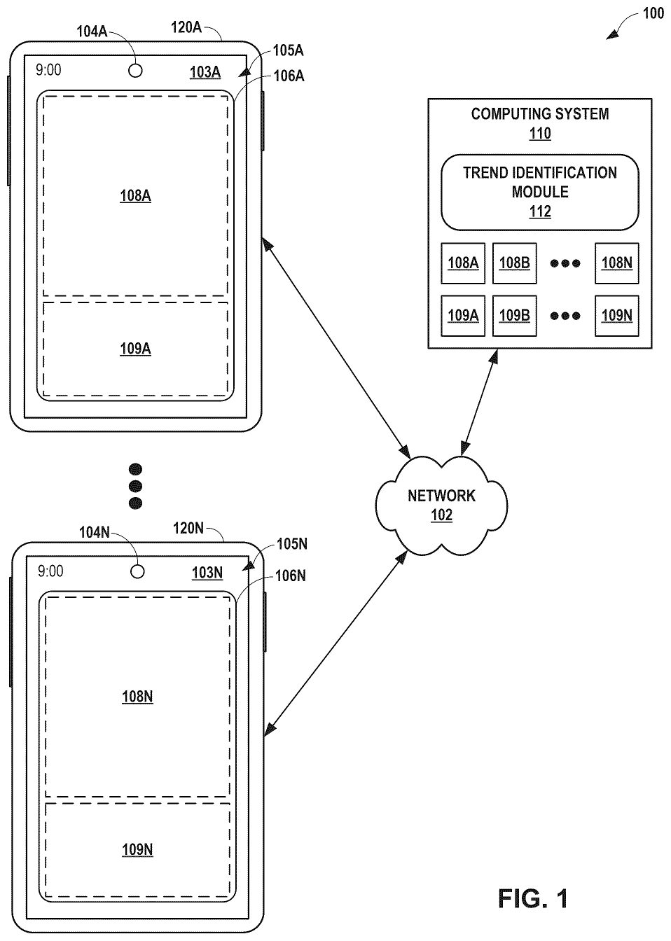

FIG. 1 is a conceptual diagram illustrating an example environment for effect trend identification using creation attribution, in accordance with one or more aspects of the present disclosure. As can be seen from the example of FIG. 1, environment 100 may include one or more computing devices 120A-120N (collectively, “computing devices 120”) that may communicate with computing system 110 over network 102. In some examples, computing devices 120 and computing system 110 may be peer devices that operate in a client/server fashion. For instance, computing devices 120 may be clients that are used to access services, such as content sharing services (e.g., video sharing services) provided by computing system 110.

As shown in the example of FIG. 1, computing device 120 may be a mobile computing device, such as a smartphone. In some examples, computing device 120 may be any type of computing device, such as a mobile phone, a tablet computer, a laptop computer, a desktop computer, a wearable device, a gaming system, a media player, an e-book reader, camera device, or a wearable computing device (e.g., a computerized watch, computerized eyewear, etc.). Computing device 120 may enable users to interact with a content sharing service (e.g., video sharing service), such as a content sharing service provided by computing system 110. In some examples, the content sharing service may comprise one or more applications 105 that execute on computing devices 120 that sends and receives information from computing system 110, such as through network 102.

Network 102 may represent any public or private communications network, for example, cellular, WI-FI®, and/or other types of networks, for transmitting data between computing systems, servers, and computing devices. Network 102 may include one or more network hubs, network switches, network routers, or any other network equipment, that are operatively inter-coupled thereby providing for the exchange of information between computing system 110 and computing device 120. Computing device 120 and computing system 110 may transmit and receive data across network 102 using any suitable communication techniques. For example, between computing system 110 and computing device 120 may communicate (e.g., transmit and receive) media content items 106A-106N (collectively, “media content items 106”) (e.g., videos), effect attributes, such as video effects 108A-108N (collectively, “video effects 108”) and/or audio effects 109A-109N (collectively, “audio effects 109”) via network 102. Each of computing device 120 and computing system 110 may be operatively coupled to network 102 using respective network links, such as Ethernet, Wi-Fi, BLUETOOTH® or any other types of wired and/or wireless network connections. Examples of media content items 106A-106N may include videos, animations, photos, graphics, drawings, images, multimedia presentations, or other content suitable for modification through application of video effect 108 and/or audio effect 109.

Computing device 120 may include one or more storage devices. In some examples, the one or more storage devices may store an operating system and one or more applications 105A-105N (collectively, “applications 105”). Computing device 120 and/or the operating system may provide an execution environment for one or more applications 105, which may send and receive information from computing system 110. In some examples, application 105 may be a social media or other content sharing application that allows users to create and post (e.g., send) media content items 106 view media content items 106, and share media content items 106 with other users.

As shown in the example of FIG. 1 for instance, computing device 120 may execute application 105 to create media content item 106 (e.g., a video) that computing device 120 may send to computing system 110. To illustrate, application 105A, when executed by computing device 102A, may capture media content item 106A (e.g., record a video or capture an image), such as through one or more imaging devices 104A (e.g., a camera), and may present media content item 106A, such as through user interface device 103A (e.g., a touch screen). Application 105A may capture and present media content items 106 in response to user commands or other input. Computing device 120A may communicate (e.g., send and receive) media content items 106 with computing system 110. Computing system 110 may share media content item 106A with other users, such as the user of computing device 120N by sending media content item 106A received from computing device 120A to computing device 120N for presentation by computing device 120N to the user of computing device 120N.

Application 105 may present media content item 106 in a user interface, such as shown in the example of FIG. 1. In some examples, the user interface may include one or more user interface elements (e.g., buttons) corresponding to one or more effect attributes such as one or more of video effects 108 and one or more of audio effects 109. Application 105 may receive a selection of one or more effect attributes, such as video effect 108, audio effect 109, or both from a user. For example, application 105 may receive touch or other user input at a user interface element (e.g., button) corresponding to at least one of video effects 108 (e.g., video effect 108A) and/or at least one of audio effects 109 (e.g., audio effect 109A).

Application 105 may assign selected effect attributes (e.g., video effect 108A and audio effect 109A) to media content item 106A. In some examples, application 105 may apply the selected effect attributes (e.g., video effect 108A and audio effect 109A) to media content item 106A and thereby modify the appearance and sound of media content item 106A. Some examples of video effects 108 include bubble face effects, dance party effects, mirrored video effects, night vision effects, wavy video effects, and bloom effects that, when applied, modify the appearance of media content item 106. Video effects 108 may also include video filters, such as color filters (e.g., black and white or color enhancement filters). Audio effects 109 may include music (e.g., soundtracks), sound effects, background noise, and other audio that may be included in media content item 106. Though shown, for illustration purposes, as portions of media content items 106A, 106N, video effects 108 and audio effects 109 may be applied to an entire media content item 106 or various portions of media content item 106. For example, if media content item 106A is a 30 second video, computing device 120A may apply video effect 108A and/or audio effect 109A to the entire 30 second duration of media content item 106A or to a portion (e.g., 5 seconds) of media content item 106A.

Application 105 may send media content item 106 and an indication of the effect attributes (e.g. video effect 108A and audio effect 109A) assigned to (e.g., selected for) media content item 106 to computing system 110. For example, application 105A may apply the effect attributes (e.g., video effect 108A and audio effect 109A) to media content item 106A and subsequently send media content item 106A to computing system 110. In some examples, rather than application 105 applying the effect attributes, application 105 may send media content item 106 along with an indication of the effect attributes (e.g., video effect 108A and audio effect 109A) to computing system 110 and computing system 110 may apply the effect attributes.

Computing system 110 may share, with other users, media content item 106 with the selected effect attributes (e.g., video effect 108A and audio effect 109A) applied to media content item 106. For example, computing system 110 may receive media content item 106A, with video effect 108A and audio effect 109A assigned thereto, from computing device 120A. Computing system 110 may share media content item 106A with other users, such as a user of computing device 120N by sending media content item 106A, modified with assigned video effect 108A and audio effect 109A (e.g., with the selected effect attributes applied), to computing devices 120 of the other users. For instance, video effect 108A may include a wavy video effect and audio effect 109A may include background music. In such an instance, computing system 110 may share media content item 106A as a “wavy video” (e.g., with the wavy video effect of video effect 108A applied) and the background music of audio effect 109A. Computing device 120N, such as through application 105N, may present media content item 106A, with video effect 108A and audio effect 109A applied, such as through user interface device 103N of computing device 120N.

Application 105 may perform operations described herein using software, hardware, firmware, or a mixture of hardware, software, and firmware residing in and/or executing at computing device 120 to create, such as by generating, capturing, and/or applying effect attributes (e.g., video effects 108 and audio effects 109) to media content items 106 as well as other functions associated with media content items 106, including storing, modifying, presenting, communicating (e.g., sharing), deleting, updating, and removing media content items 106, or various subsets thereof. Computing device 120 may execute application 105 with multiple processors or multiple devices, as virtual machines executing on underlying hardware, as one or more services of an operating system or computing platform, and/or as one or more executable programs at an application layer of a computing platform of computing device 120.

Computing system 110 may perform effect trend identification using creation attribution based on media content items 106 received from computing devices 120. As will be described further below, computing system 110 may include one or more storage devices that store data related to performing effect trend identification in accordance with the techniques disclosed herein. For example, one or more storage devices of computing system 110 may store media content items 106, including selected video effects 108, audio effects 109, or indications thereof, received from computing device 120. In some examples, one or more storage devices of computing system 110 may store sets of effect attributes, such as sets of video effects 108, sets of audio effects 109, or both which constitute the effect attributes that are available to users at computing devices 120. Computing system 110 may provide an indication of the available effect attributes to computing devices 120. Applications 105 may enable users to select from and apply the available effect attributes at computing devices 120 to create media content items 106. One or more storage devices of computing system 110 may store creation attribution information, and other data related to performing effect trend identification in accordance with the techniques disclosed herein. A storage device may store data in one or more repositories (e.g., databases, file systems, other structured data).

Creation attribution information may indicate whether a media content item inspired creation of another media content item, such as by including a creation attribute for one or more media content items, as well as other metrics for each media content item of media content items 106. In some examples, creation attribution information may include consumption information indicating, for each of media content items 160, whether the media content item was watched, when the media content item was watched, the user that watched the media content item, the number of times the media content item was watched, etc. Creation attribution information may identify effect attributes (e.g., video effects 108 and audio effects 109) assigned or applied to respective media content items 106.

Computing system 110 may include a trend identification module 112. For example, trend identification module 112 may be stored on a storage device of computing system 110. In some examples, computing system 110 may provide an execution environment for trend identification module 112, such as through one or more processors and/or an operating system. Trend identification module 112 may identify effect trends using creation attribution. For example, trend identification module 112 may determine media content item 106A, with a video effect 108A and audio effect 109A applied thereto, has a creation attribute when media content item 106A inspires a user to create another media content item 106N including the same effect attributes (e.g., video effect 108A and audio effect 109A). As will be described further below, trend identification module 112 may utilize media content items 106 having creation attributes as seed content to identify other media content items 106 within an effect trend. Computing system 110 may provide (e.g., send) the effect trend to users, such as in the form of a content feed including media content items 106 within the effect trend.

In operation, to determine whether media content item 106A has inspired creation of another media content item 106N, trend identification module 112 may determine whether media content item 106A satisfies particular criteria. For example, to determine whether media content item 106A has inspired creation of another media content item 106N, trend identification module 112 may determine media content item 106A and media content item 106N have the same effect attributes (e.g., the same video effect 108 and the same audio effect 109) and determine whether media content item 106N was created by a user that viewed media content item 106A prior to creating media content item 106N. Trend identification module 112 may assign a creation attribute to media content item 106A, such as in the creation attribution information, when media content item 106A has inspired creation of media content item 106B.

For example, application 105A of computing device 120A may create media content item 106A with video effect 108A and audio effect 109A and computing device 120A may send media content item 106A to computing system 110, such as in response to user input from a first user. Computing system 110 may share media content item 106A to a second user at computing device 120N by sending media content item 106A to computing device 120N.

Computing device 120N may receive and present media content item 106A, such as through user interface device 103N, to a second user (e.g., the user of computing device 120N). The second user may be inspired to create one or more other media content items 106. For instance, application 105N, in response to user input from the second user, may capture media content item 106N, such as through imaging device 104 of computing device 120N. Application 105N may receive a selection of one or more effect attributes (e.g., video effect 108A and audio effect 109A) from the second user. Application 105N of computing device 120N may send media content item 106N and an indication of the selected effect attributes to computing system 110.

Computing system 110 may receive and store both media content item 106A and media content item 106B along with respective indications of the selected effect attributes for media content item 106A and media content item 106. Trend identification module 112 may determine whether media content item 106A has a creation attribute by determining whether media content item 106N has the same effect attributes (e.g., video effect 108A and audio effect 109A) as media content item 106A and whether media content item 106N was created after the second user viewed media content item 106A (e.g., after computing device 120N presented media content item 106A to the second user). If media content item 106N has the same effect attributes (e.g., video effect 108A and audio effect 109A) as media content item 106A and media content item 106N was created after the second user viewed media content item 106A, trend identification module 112 may assign a creation attribute to media content item 106A. If media content item 106N and media content item 106A do not have the same effect attributes or media content item 106N was not created after computing device 120N presented media content item 106A to the second user, trend identification module 112 may refrain from assigning a creation attribute to media content item 106A.

In some examples, computing system 110 may require a temporal attribute before determining media content item 106A has the creation attribute. For example, computing system 110 may require media content item 106A to inspire creation of another media content item 106N with the same effect attributes within a particular time period. Continuing the above example for instance, computing system 110 may require media content item 106N to have the same effect attributes as media content item 106A and require media content item 106N to have been created within a predetermined period of time (e.g., 7 days) of computing device 120N presenting media content item 106A to the second user prior to assigning a creation attribute to media content item 106A. As such, if media content item 106N is created after the predetermined period of time elapsed (e.g., after 7 days of computing device 120N presenting media content item 106A to the second user), computing system 110 may refrain from assigning a creation attribute to media content item 106A, at least relative to media content item 106N, even when media content item 106N has the same effect attributes as media content item 106A.

Trend identification module 112 may identify one or more effect trends in media content items 106 received by computing system 110 from computing devices 120 using inspiring media content items 106 as seed content. Trend identification module 112 may consider media content items 106 with respective creation attributes to be seed content items. Trend identification module 112 may use the seed content items to identify other media content items 106 that form an effect trend. For example, trend identification module 112 may identify a set of media content items 106 that have the same effect attributes (e.g., video effect 108A and audio effect 109A) as the seed content item (e.g., media content item 106A) to form an effect trend.

In some examples, trend identification module 112 may identify a plurality of seed content items (e.g., a plurality of media content items 106 that each qualify as seed content by virtue of being assigned the creation attribute). In such a case, trend identification module 112 may apply various criteria to select a seed content item from the plurality of seed content items. In some examples, trend identification module 112 may utilize inspiration metrics, including a number of unique channels, a conversion rate, lifetime views, or various subsets thereof to select a particular seed content item from the plurality of seed content items. For instance, trend identification module 112 may select media content item 106 with the highest or most desirable inspiration metric(s), relative to other seed content items, to be the seed content item.

In some examples, trend identification module 112 may identify the set of media content items 106 that form an effect trend based on the seed content item and a topic or concept (e.g., dance videos, Halloween videos, family videos, plant videos) of each respective media content item 106. For instance, trend identification module 112 may identify the set of media content items 106 that form the effect trend such that each media content item 106 in the set has the same effect attributes as the seed content item and a similar concept as the seed content item. As such, in some examples, the set of media content items 106 may share a theme or concept with the seed content item. Trend identification module 112 may utilize any suitable technique for determining whether media content items 106 share a similar concept.

For example, trend identification module 112 may utilize an embedding space, such as a multi-dimensional embedding space to determine whether media content items 106 include a similar concept. For example, trend identification module 112 may generate an embedding for each media content item 106 that specifies a location for each respective media content item 106 within the embedding space based on one or more concepts contained in each respective media content item. Trend identification module 112 may generate the embeddings such that distances in the embedding space correspond to similarity in concepts between media content items 106. As such, media content items 106 with similar concepts may be separated by smaller distances as compared to media content items 106 with dissimilar concepts which may be separated by relatively larger distances.

Trend identification module 112 may use these embeddings to cluster media content items 106 with similar concepts together in the embedding space. In some examples, trend identification module 112 may determine media content items 106 within a threshold distance of seed content (e.g., media content item 106A) to include similar concepts and determine media content items 106 beyond the threshold distance to include dissimilar concepts. Trend identification module 112 may determine media content items 106 within the threshold distance of the seed content item (e.g., within a cluster including the seed content) form an effect trend.

Computing system 110 may cause the set of media content items 106 to be presented as an effect trend to one or more users, such as in the form of a media content item feed (e.g., video feed). For example, computing system 110 may send the effect trend, such as by sending an indication of media content items 106 in the set of media content items 106, to computing devices 120. Computing devices 120 may execute application 105 to present individual media content items 106 in the media content item feed to users, such as by presenting the media content item feed as a sequence of individual media content items 106 within the effect trend.

As such, by identifying seed media content items 106 based on the creation attribute, computing system 110 may identify effect trends that are inspiring and share common characteristics, such as effect attributes (e.g., video effects 108 and audio effects 109) and/or concepts (e.g., topics). Identification of effect trends in this manner (e.g., based on creation attributes and common characteristics) enhances the effect trends outputted by computing system 110 by ensuring not only that media content items 106 within an effect trend are likely to inspire users but also that media content items 106 conform to shared characteristics (e.g., common effect attributes and/or concepts).

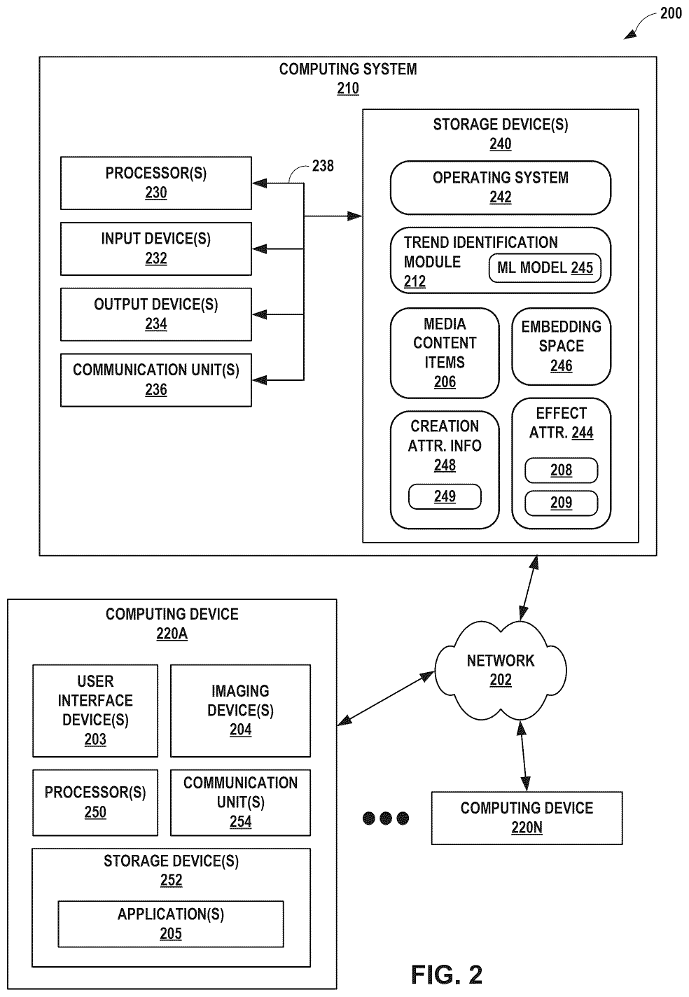

FIG. 2 is a block diagram illustrating an example environment for effect trend identification using creation attribution, in accordance with one or more aspects of the present disclosure. As can be seen, environment 200 may include a computing system 210, one or more computing devices 220A-220N (collectively, “computing devices 220”), and network 202. Computing system 210, computing devices 220, and network 202 of FIG. 2 are described below as an example of computing system 110, computing devices 120, and network 102 as illustrated in FIG. 1.

Computing system 210 may be any suitable computing system, such as one or more desktop computers, laptop computers, mainframes, servers, cloud computing systems, virtual machines, etc. capable of sending and receiving information via network 202. In some examples, computing system 210 may represent a cloud computing system that provides one or more services via network 202. That is, in some examples, computing system 210 may be a distributed computing system. One or more computing devices, such as computing devices 220, may access the services provided by the cloud by communicating with computing system 210. FIG. 2 illustrates only one particular example of computing system 210, and many other examples of computing system 210 may be used in other instances and may include a subset of the components included in example computing system 210 or may include additional components not shown in FIG. 2.

As shown in the example of FIG. 2, computing system 210 may include one or more processors 230, one or more input devices 232, one or more output devices 234, one or more communication units 236, and one or more storage devices 240. Storage device 240 of computing system 210 may include operating system 242 and trend identification module 212, which may respectively be examples of an operating system and trend identification module 112 of FIG. 1. Communication channels 238 may interconnect each of the components 230, 232, 234, 236 and 240 for inter-component communications (physically, communicatively, and/or operatively). In some examples, communication channels 238 may include a system bus, a network connection, an inter-process communication data structure, or any other method for communicating data.

One or more input devices 232 of computing system 210 may receive input. Examples of input are tactile, audio, and video input. Input devices 232 of computing system 210, in one example, includes a presence-sensitive display, touch-sensitive screen, mouse, keyboard, voice responsive system, video camera, microphone or any other type of device for detecting input from a human or machine.

One or more output devices 234 of computing system 210 may generate output. Examples of output are tactile, audio, and video output. Output devices 234 of computing system 210, in one example, includes a presence-sensitive display, sound card, video graphics adapter card, speaker, liquid crystal display (LCD), organic light-emitting diode (OLED) display, a light field display, haptic motors, linear actuating devices, or any other type of device for generating output to a human or machine.

One or more communication units 236 of computing system 210 may communicate with external devices via one or more wired and/or wireless networks by transmitting and/or receiving network signals on the one or more networks. Examples of one or more communication units 236 include a network interface card (e.g., an Ethernet card), an optical transceiver, a radio frequency transceiver, or any other type of device that can send and/or receive information. Other examples of one or more communication units 236 may include short wave radios, cellular data radios, wireless network radios, as well as universal serial bus (USB) controllers.

One or more processors 230 may implement functionality and/or execute instructions within computing system 210. For example, one or more processors 230 of computing system 210 may receive and execute instructions stored by one or more storage devices 240 that execute the functionality of operating system 242 and trend identification module 212.

The instructions executed by one or more processors 230 may cause computing system 210 to store information within one or more storage devices 240 during program execution.

Examples of one or more processors 230 include application processors, display controllers, sensor hubs, and any other hardware configured to function as a processing unit. One or more processors 230 may execute instructions of operating system 242 and trend identification module 212 to perform actions or functions. That is, operating system 242 and trend identification module 212 may be operable by one or more processors 222 to perform various actions or functions of computing system 210.

For example, trend identification module 212 may identify effect trends based on creation attribution as described with respect to trend identification module 112 of FIG. 1. For instance, trend identification module 212 may identify media content items 206 that qualify as seed content based on whether media content items 206 have a creation attribute 249. Trend identification module 212 may use the seed content to identify other media content items 206 with the same effect attributes, concepts, or both to identify an effect trend.

In some examples, trend identification module 212 may include one or more machine learning (ML) models 245 which trend identification module 212 may apply to determine an embedding within embedding space 246 for individual media content items 206. As described above, trend identification module 212 may generate an embedding for each media content item 206 that specifies a location for each respective media content item within the embedding space based on one or more concepts contained in each respective media content item. Trend identification module 212 may generate the embeddings such that distances in the embedding space correspond to similarity in concepts between media content items 206. As such, within embedding space 246, media content items 206 with similar concepts may be separated by smaller distances as compared to media content items 206 with dissimilar concepts.

Trend identification module 212 may utilize embedding space 246 to identify media content items 206 within an effect trend. For example, trend identification module 212 may determine media content items 206 within a predetermined distance of the seed content to include similar concepts and determine media content items 206 beyond the predetermined distance to include dissimilar concepts. Trend identification module 212 may determine media content items 206 that are within the predetermined distance of the seed content (e.g., within a cluster including the seed content) from the effect trend.

Computing system 210 may generate ML model 245 using various training techniques, including supervised, unsupervised, semi-supervised, and reinforcement learning techniques, utilizing one or more training data sets including previous examples of media content items 206 and their embeddings within an embedding space. For example, supervised or unsupervised reinforcement learning techniques may be used to generate ML model 245 that, when applied by trend identification module 212, generates an embedding that accurately identifies a location for media content item 206 within embedding space 246. During training, computing system 210 may validate embeddings generated by ML model 245 using a validation data set where the embeddings generated by ML model 245 are compared to previously validated embeddings, such as embeddings validated by human validators.

ML model 245 may be or include one or more of various different types of machine-learned models. Examples of such different types of machine-learning models are provided below for illustration. One or more of the example models described below may be used (e.g., combined) to provide an embedding within embedding space 246 for individual media content items 206 in response to input data including individual media content items 206 or indications thereof. Additional models beyond the example models provided below may be used as well.

In some implementations, ML model 245 may be or include one or more classifier models such as, for example, linear classification models; quadratic classification models; etc. ML model 245 may be or include one or more regression models such as, for example, simple linear regression models; multiple linear regression models; logistic regression models; stepwise regression models; multivariate adaptive regression splines; locally estimated scatterplot smoothing models; etc. In some examples, ML model 245 may be or include one or more generative networks such as, for example, generative adversarial networks. Generative networks may be used to generate new data such as artificial feedback texts.

In some examples, ML model 245 may be or include one or more artificial neural networks (also referred to simply as neural networks). A neural network may include a group of connected nodes, which also may be referred to as neurons or perceptrons. A neural network may be organized into one or more layers. Neural networks that include multiple layers may be referred to as “deep” networks. A deep network may include an input layer, an output layer, and one or more hidden layers positioned between the input layer and the output layer. The nodes of the neural network may be connected or non-fully connected.

One or more neural networks may be used to provide an embedding within embedding space 246 for individual media content items 206. For example, the embedding may be a representation of knowledge abstracted from input data, such as media content items 206, into one or more learned dimensions. In some instances, embeddings may be a useful source for identifying related entities. In some instances, embeddings may be extracted from the output of the network, while in other instances embeddings may be extracted from any hidden node or layer of the network (e.g., a close to final but not final layer of the network).

In some examples, machine learning module 210 may perform or be subjected to one or more reinforcement learning techniques such as Markov decision processes; dynamic programming; Q functions or Q-learning; value function approaches; deep Q-networks; differentiable neural computers; asynchronous advantage actor-critics; deterministic policy gradient; etc.

One or more storage devices 240 within computing system 210 may store information for processing during operation of computing system 210. That is, computing system 210 may store data accessed by operating system 242 and trend identification module 212 during execution at computing system 210, including media content items 206, effect attributes 244, and embedding space 246, which may respectively be examples of media content items 106, the effect attributes, and the embedding space, described above with respect to FIG. 1. As shown in FIG. 2, effect attributes 244 may include one or more video effects 208, one or more audio effects 209, or both. Video effects 208 and audio effects 209 may be examples of video effects 108 and audio effects 109 of FIG. 1, respectively speaking.

Computing system 210 may store creation attribution information 248, such as to one or more storage devices 240, that may be accessed by trend identification module 212 during execution at computing system 210. Creation attribution information 248 may include data related to determining whether media content items 206 have inspired creation of other media content items. As shown in FIG. 2 for example, creation attribution information 248 may include one or more creation attributes 249. Creation attributes 249 may be examples of the creation attributes described above with respect to FIG. 1. Creation attribution information 248 may include information identifying media content items 206, video effects 208, audio effects 209, user identifiers, media content item consumption information, and the like as will be described further below.

In some examples, storage device 240 is a temporary memory, meaning that a primary purpose of storage device 240 is not long-term storage. One or more storage devices 240 on computing system 210 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

One or more storage devices 240, in some examples, also include one or more computer-readable storage media. One or more storage devices 240 may be configured to store larger amounts of information than volatile memory. One or more storage devices 240 may further be configured for long-term storage of information as non-volatile memory space and retain information after power on/off cycles. Examples of non-volatile memories include magnetic hard disks, optical disks, floppy disks, flash memories, or forms of electrically programmable memories (EPROM) or electrically erasable and programmable (EEPROM) memories. One or more storage devices 240 may store program instructions and/or information (e.g., data) associated with operating system 242 and trend identification module 212. Trend identification module 212 may execute at one or more processors 230 to perform functions similar to that of trend identification module 212 of FIG. 1.

Computing device 220 may be an example of a smartphone, mobile phone, a tablet computer, a laptop computer, a desktop computer, a wearable device, a gaming system, a media player, an e-book reader, camera device, or a wearable computing device (e.g., a computerized watch, computerized eyewear, etc.), or other computing device. FIG. 2 illustrates a particular example of computing device 220, and many other examples of computing device 220 may be used in other instances and may include a subset of the components included in example computing device 220 or may include additional components not shown in FIG. 2.

Computing device 220 includes one or more user interface devices 203, one or more imaging devices 204, one or more processors 250, one or more storage devices 252, and one or more communication units 254. One or more storage devices 252 of computing device 220 may include an operating system that provides an execution environment for one or more applications, such as applications 105 described with respect to FIG. 1.

User interface device 203 of computing device 220 may be hardware that functions as an input and/or output device for computing device 220. For example, user interface device 203 may include a display component, which may be a screen at which information is displayed by user interface device 203 and a presence-sensitive input device that may detect an object at and/or near the display component. The presence-sensitive input device may, for example, detect a user's touch or other input.

One or more communication units 254 of computing device 220 may communicate with external devices by transmitting and/or receiving communication signals, such as via one or more wireless networks or wireless connections. Examples of one or more communication units 254 include a network interface card (e.g., Ethernet or WI-FI card), an optical transceiver, a radio frequency transceiver, a global positioning system (GPS) receiver, or any other type of device that can send and/or receive information. Other examples of one or more communication units 254 may include short wave radios, cellular data radios, wireless network radios, as well as universal serial bus (USB) controllers or any other type of device that can send and/or receive information over a wired or wireless connection.

One or more processors 250 may implement functionality and/or execute instructions within computing device 220. For example, one or more processors 250 on computing device 220 may receive and execute instructions stored by one or more storage devices 252 that execute the functionality of one or more applications 205. Applications 205 may be examples of applications 105 of FIG. 1. The instructions executed by one or more processors 250 may cause computing device 220 to store information within one or more storage devices 252 during program execution. Examples of one or more processors 250 include application processors, display controllers, sensor hubs, and any other hardware configured to function as a processing unit.

One or more storage devices 252 within computing device 220 may store information for processing during operation of computing device 220. That is, computing device 220 may store data accessed by applications 205 during execution at computing device 220, including media content items 206, effect attributes 244, video effects 208, audio effects 209, and creation attributes 249, other data, or various subsets thereof. In some examples, storage device 252 is a temporary memory, meaning that a primary purpose of storage device 252 is not long-term storage. One or more storage devices 252 on computing device 220 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

One or more storage devices 252, in some examples, also include one or more computer-readable storage media. One or more storage devices 252 may be configured to store larger amounts of information than volatile memory. One or more storage devices 252 may further be configured for long-term storage of information as non-volatile memory space and retain information after power on/off cycles. Examples of non-volatile memories include magnetic hard disks, optical disks, floppy disks, flash memories, or forms of electrically programmable memories (EPROM) or electrically erasable and programmable (EEPROM) memories. One or more storage devices 252 may store program instructions and/or information (e.g., data) associated with applications 205.

One or more applications 205 may execute at one or more processors 250 to perform functions related to interacting with computing system 210. For example, one or more applications 205 may create media content items 206, share media content items 206 (e.g., send media content items 206 to computing system 210), and present media content items 206 received from computing system 210. One or more applications 205 may execute at one or more processors 250 to apply effect attributes 244 (e.g., video effects 208 and audio effects 209) selected by a user to media content items 206 and send indications of selected effect attributes 244 to computing system 210.

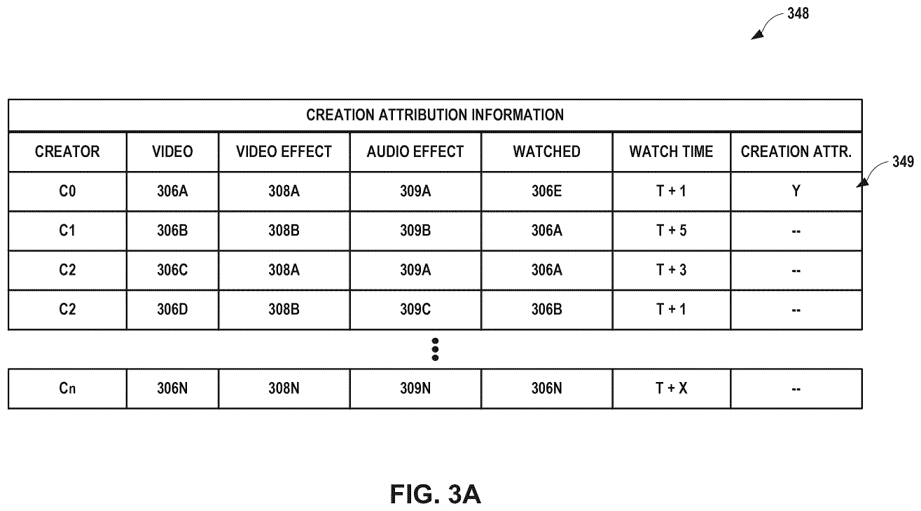

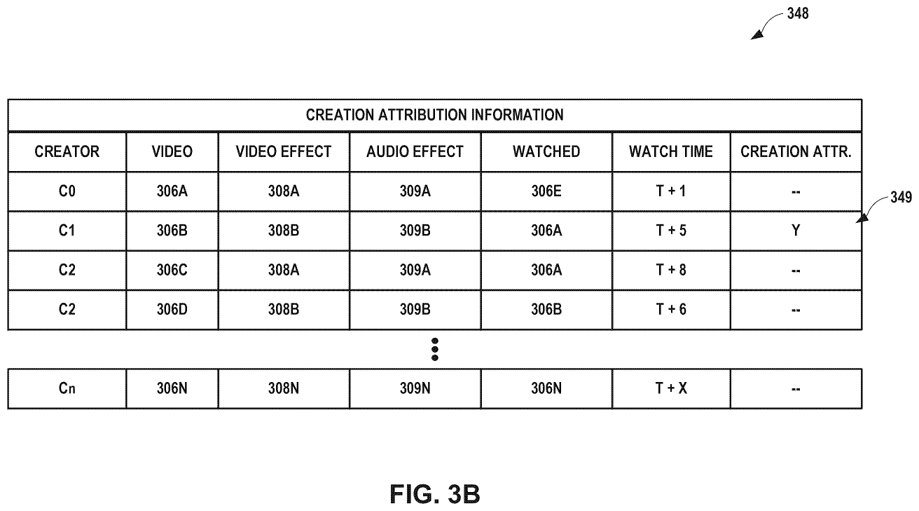

FIG. 3A-3B illustrate respective examples of creation attribution information, in accordance with one or more aspects of the present disclosure. Creation attribution information 348 may include data related to determining whether media content items 306A-306N (collectively, “media content items 306”) have inspired creation of other media content items. As shown in FIG. 3A-3B for example, creation attribution information 348 may include information identifying media content items 306 (e.g., videos), video effects 308A-308N (collectively, “video effects 308”), audio effects 309A-309N (collectively, “audio effects 309”), one or more creation attributes 349, creator identifiers (e.g., user identifiers), and media content item consumption information (e.g., watch indicators and watch times), or various subsets thereof.

Creation attribution information 348, media content items 306, video effects 308, audio effects 309, and creation attributes 349 of FIG. 3A-3B may be an example of creation attribution information 248, media content items 206, video effects 208, audio effects 209, and creation attributes 249 of FIG. 2. FIG. 3A-3B are described below in the context of FIG. 1. Computing system 110 may use creation attribution information 348 to identify media content items 306 that constitute seed content. For example, computing system 110 may determine media content item 306 is seed content when media content item 306 has creation attribute 349, as will now be described.

Referring to the examples of FIG. 3A-3B, creation attribution information 348 may indicate media content items 306 and their respective creators (e.g., users). For example, in the example of FIG. 3A-3B, creation attribution information 348 indicates creator C0 created media content item 306A, creator C1 created media content item 306B, and creator C2 created media content item 306C and media content item 306D. Creation attribution information 348 may indicate video effects 308 and audio effects 309 used in media content items 306. In the example of FIG. 3A for instance, media content item 306A has video effect 308A and audio effect 309A, media content item 306B has video effect 308B and audio effect 309B, media content item 306C has video effect 308A and audio effect 309A, and media content item 306D has video effect 308B and audio effect 309C. As can be seen, one or more media content items 306 may share one or more of video effects 308 or audio effects 309. For instance, media content item 306A and media content item 306C both use video effect 308A and audio effect 309A while media content item 306B and media content item 306D utilize different video and audio effects.

Creation attribution information 348 may also include media consumption information. For example, creation attribution information 348 may indicate whether media content item 306 has been watched, when media content item 306 was watched, or both. As shown in FIG. 3A-3B for instance, creation attribution information 348, as illustrated by the “watched” column, may indicate which media content item 306 has been watched by which creator. To illustrate, as shown in FIG. 3A, creators C1 and C2 have each watched media content item 306A and creator C0 has watched media content item 306E. As is also shown, for example, creation attribution information 348, as illustrated by the “watch time” column, may indicate a time when media content item 306 was watched.

In the example of FIG. 3A, creation attribution information 348 indicates watch time in relative terms, namely, T plus X, where T is the creation time of the watched media content item and X is the amount of time (e.g., number of days) that elapsed between the creation time and the watch time. As such, referring to the example of FIG. 3A, creator C0 watched media content item 306E at time T+1 which, in this example, corresponds to one day after media content item 306E was created. Similarly, creator C1 watched media content item 306A at time T+5 (e.g., five days after media content item 306A was created), creator C2 watched media content item 306A at time T+3 (e.g., three days after media content item 306A was created), and creator C3 watched media content item 306B at time T+1 (e.g., one day after media content item 306B was created). Though described using particular time periods (e.g., days), watch time may be represented in various ways, including absolute time (e.g., Jun. 3, 2024, 9 AM, etc.)

Computing system 110 may utilize at least a portion of creation attribution information 348 to determine whether media content item 306 has creation attribute 349. For example, computing system 110 may determine media content item 306A has creation attribute 349, as represented by the “Y” of FIG. 3A, when media content item 306A, after being watched, inspires the creation of another media content item with the same effect attributes, in this case video effect 308A and audio effect 309A. As can be seen, computing system 110 determines media content item 306A has creation attribute 349 because, based on creation attribution information 348, creator C2 watched media content item 306A at time T+3 (e.g., three days after media content item 306A was created) and created media content item 306C with the same effect attributes, namely, video effect 308A and audio effect 309A. In contrast, computing system 110 determines media content items 306B-306D do not have creation attribute 349 because, based on creation attribution information 348, media content items 306B-306D do not satisfy the above criteria. More specifically, computing system 110 determines, based on creation attribution information 348, that no other media content items 306N with the same effect attributes as those of media content items 306B-306D, respectively, were created after media content items 306B-306D were watched after being watched. For example, creator C2 watched media content item 306B and created media content item 306D at time T+1 (e.g., one day after watching media content item 306B); however, media content item 306D includes audio effect 309C while media content item 306B includes audio effect 309B.

In some examples, computing system 110 may include watch time as a criteria for determining whether media content item 306 has creation attribute 349. For example, computing system 110 may require a watch time of less than T+7 (e.g., seven days after media content item 306 was created) to determine media content item 306 has creation attribute 349. As can be seen, creation attribution information 348 in the example of FIG. 3A indicates creator C2 created media content item 306C at time T+3 after media content item 306E was watched which is less than T+7. As such, computing system 110 still determines media content item 306A has creation attribute 349 in this example as media content item 306A satisfies the criteria for creation attribute 349 (e.g., media content item 306C has the same effect attributes as media content item 306A, was created after creator C2 watched media content item 306A, and media content item 306C was created within the watch time constraint, T+7.

In contrast, if creator C2 created media content item 306C at time T+8 after watching media content item 306A, such as shown in creation attribution information 348 of the example of FIG. 3B, computing system 110 may determine media content item 306A does not have creation attribute 349 due to the watch time of T+8 being greater than the watch time criteria of T+7 (and even though the other criteria for creation attribute 349 are satisfied). As can be seen, in the example of FIG. 3B, creation attribution information 348 indicates creator C2 created media content item 306D after watching media content item 306B at time T+6. Media content item 306D has the same effect attributes namely, video effect 308B and audio effect 309B, as media content item 306B. As such, because time T+6 is less than the watch time criteria of T+7, computing system 110 may determine media content item 306B has creation attribute 349.

Though the examples of FIG. 3A-3B illustrate creation attribution information 348 in the form of a table, creation attribution information 348 may be stored, such as to a storage device, such as storage device 240 of FIG. 2, of computing system 110, in various forms of structured data including tables, lists, arrays, and the like. In some examples, creation attribution information 348 may be stored as a database table, such as to a storage device (e.g., storage device 240 of FIG. 2) of computing system 110.

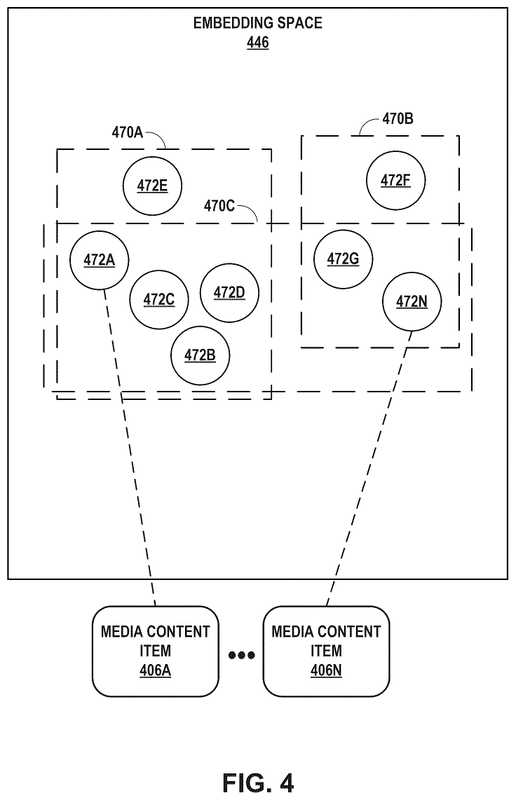

FIG. 4 is a block diagram illustrating an example embedding space, in accordance with one or more aspects of the present disclosure. FIG. 4 is described below in the context of FIG. 1-2. Embedding space 446 and media content items 406A-406N (collectively, “media content items 406”) of FIG. 4 may be examples of embedding space 246 and media content items 206 of FIG. 2. As can be seen, embedding space 446 may include a plurality of embeddings 472A-472N (collectively, “embeddings 472”) that individually correspond to one of a plurality of media content items 406. As described above, computing system 110, such as through trend identification module 112, may generate and/or assign individual embeddings 472 to each media content item of media content items 406. Computing system 110 may generate embeddings 472 such that media content items 406 with similar concepts (e.g., similar topics) are separated by a smaller distance as compared to media content items 106 with dissimilar concepts within embedding space 446. Though illustrated in a two-dimensional view, computing system 110 may use embedding spaces 446 of various dimensions (e.g., 3, 4, 10, etc. dimensions).

Embeddings 472 may each identify the location of a respective media content item 406 within embedding space 446. As shown in the example of FIG. 4 for instance, embedding 472A identifies the location of media content item 406A in embedding space and embedding 472N identifies the location of media content item 406N in embedding space 446. Only media content items 406A, 406N are shown in FIG. 4 for purposes of brevity. Though not shown, each of embeddings 472 may correspond to one of media content items 406 and identify the location of the corresponding media content item in embedding space 446.

Computing system 110 may use embedding space 446 to identify effect trends 470A-470C (collectively, “effect trends 470) comprising a subset of media content items 406. For example, computing system 110 may identify media content item 406A as seed content and include media content items 406 with embeddings 472 within a predetermined distance of embedding 472A in effect trend 470. For instance, computing system 110 may identify media content items 406 corresponding to embeddings 472A-472E as effect trend 470A. Computing system 110 may utilize various predetermined distances. For example, computing system 110 may enlarge the above predetermined distance and identify media content items 406 corresponding to embeddings 472A, 472B, 472C, 472D, 472G, 472N as effect trend 470C. Computing system 110 may identify different effect trends 470 based on different seed content. For example, computing system 110 may identify media content items 106 corresponding to embeddings 472F, 472G, 472N as effect trend 470B when media content item 406N is identified as the seed content.

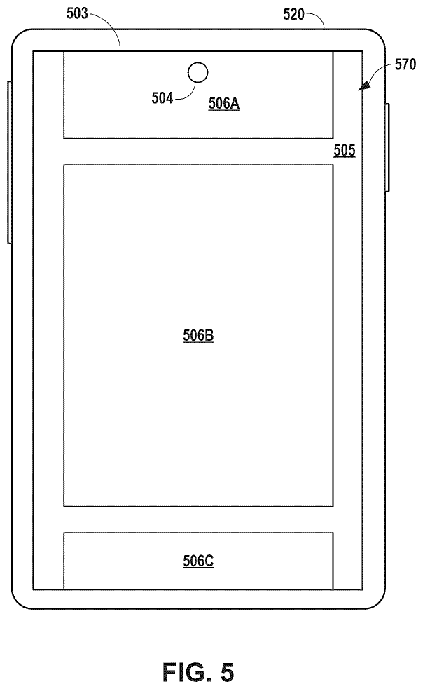

FIG. 5 is a conceptual diagram illustrating an example computing device, in accordance with one or more aspects of the present disclosure. Computing device 520 of FIG. 5 may be an example of computing device 120 of FIG. 1 and may include application 505, user interface device 503 and/or imaging device 504, which may be examples of user application 105, interface device 103 and imaging device 104 of FIG. 1. In the example of FIG. 5, computing device 520 executes application 505 to present an effect trend 570 including a plurality of media content items 506. Computing device 520 may receive effect trend and media content items 506A-506C (collectively, “media content items 506”) of effect trend 570 from a computing system, such as computing system 110 of FIG. 1. In operation, users may consume (e.g., view) effect trend 570 and media content items 506 of effect trend 570 via user interface device 503 of computing device 520, such as by swiping, scrolling or through other user input provided by the user to computing device 520. As can be seen, application 505 may present effect trend 570 in the form of a media content item feed comprising individual media content items 506.

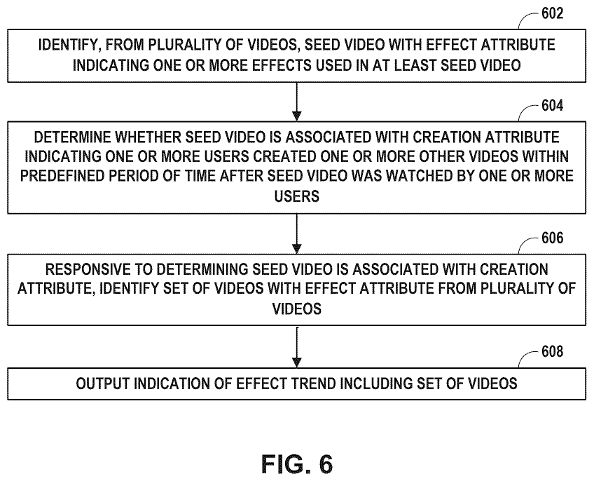

FIG. 6 is a flowchart illustrating an example process for effect trend identification using creation attribution, in accordance with one or more aspects of the present disclosure. FIG. 6 is described below in the context of FIG. 1-5.

Computing system 110 may identify, from a plurality of media content items 106, a seed media content item 106A one or more effect attributes 244 indicating one or more effects (e.g., video effect 108, audio effect 109) used in at least the seed media content item (602). Computing system 110 may identify seed media content item 106A by identifying seed media content item 106A from a set of seed media content items where each seed media content item in the set of seed media content items includes the one or more effect attributes 244 (e.g., video effect 108, audio effect 109). The one or more effects used in at least seed media content item 106A may be a particular video effect 108 (e.g., video effect 108A) and a particular audio effect 109 (e.g., audio effect 109A). In some examples, seed media content item 106A may have a higher inspiration metric compared to one or more other seed media content items from the set of seed media content items. The inspiration metric may include one or more of a number of unique channels, a conversion rate, or lifetime views.

Computing system may determine whether seed media content item 106A is associated with a creation attribute 249 indicating one or more users created one or more other media content items 106 including the one or more effect attributes 244 (e.g., video effect 108A, audio effect 109A) within a predefined period of time (e.g., 7 days) after seed media content item 106A was watched by the one or more users (604).

Computing system 110 may, responsive to determining seed media content item 106A is associated with creation attribute 249, identify a set of media content items with the one or more effect attributes 244 (e.g., video effect 108A, audio effect 109A) from the plurality of media content items 106 (606). Each media content item 106 in the set of media content items may be associated with an embedding 472 in an embedding space 446 that is within a predetermined distance of an embedding of the seed media content item in the embedding space 446. In this manner, computing system 110 may ensure each media content item 106 in the set of media content items shares a concept with seed media content item 106A.

Computing system 110 may output an indication of an effect trend 570 including the set of media content items (608). Computing system 110 may send the indication of effect trend 570 to a computing device 120. In some examples, computing system 110 may output effect trend 570 as a media content item feed (e.g., video feed) where each media content item in the set of media content items is presented, such as through a user interface device 503 of computing device 520, in a sequence. Computing system 110 may determine the set of media content items contains fewer than a threshold number of media content items. Responsive to determining the set of media content items contains fewer than the threshold number of media content items, computing system 110 may refrain from providing effect trend 570 including the set of media content items.

In some examples, one or more processors 230 execute trend identification module 212 to provide the functionality described above with respect to the flowchart of FIG. 6.

Aspects of this disclosure include the following examples.
Example 1: A method includes identifying, by a computing system and from a plurality of media content items, a seed media content item with one or more effect attributes indicating one or more effects used in at least the seed media content item; determining, by the computing system, whether the seed media content item is associated with a creation attribute indicating one or more users created one or more other media content items including the one or more effects within a predefined period of time after the seed media content item was watched by the one or more users; responsive to determining the seed media content item is associated with the creation attribute, identifying, by the computing system, a set of media content items with the one or more effect attributes from the plurality of media content items; and outputting, by the computing system, an indication of an effect trend including the set of media content items.
Example 2: The method of example 1, wherein each media content item in the set of media content items is associated with an embedding in an embedding space that is within a predetermined distance of an embedding of the seed media content item in the embedding space.
Example 3: The method of example 1, further comprising providing, by the computing system, the effect trend to a computing device through a media content item feed that presents each media content item in the set of media content items in a sequence.
Example 4: The method of example 1, further includes determining, by the computing system, the set of media content items contains fewer than a threshold number of media content items; and responsive to determining the set of media content items contains fewer than the threshold number of media content items, refraining, by the computing system, from providing the effect trend including the set of media content items.
Example 5: The method of example 1, wherein the one or more effects used in at least the seed media content item is a particular video effect and a particular audio effect.
Example 6: The method of example 1, wherein the one or more effects used in at least the seed media content item is a particular audio effect.
Example 7: The method of example 1, wherein identifying the seed media content item comprises identifying, by the computing system, the seed media content item from a set of seed media content items and each seed media content item in the set of seed media content items includes the one or more effect attributes.
Example 8: The method of example 7, wherein the seed media content item has a higher inspiration metric compared to one or more other seed media content items from the set of seed media content items, the inspiration metric comprising one or more of a number of unique channels, a conversion rate, or lifetime views.
Example 9: A computing system includes a memory that stores instructions; and processing circuitry that executes the instructions to: identify, from a plurality of media content items, a seed media content item with one or more effect attributes indicating one or more effects used in at least the seed media content item; determine whether the seed media content item is associated with a creation attribute indicating one or more users created one or more other media content items including the one or more effects within a predefined period of time after the seed media content item was watched by the one or more users; responsive to determining the seed media content item is associated with the creation attribute, identify a set of media content items with the one or more effect attributes from the plurality of media content items; and output an indication of an effect trend including the set of media content items.
Example 10: The computing system of example 9, wherein each media content item in the set of media content items is associated with an embedding in an embedding space that is within a predetermined distance of an embedding of the seed media content item in the embedding space.
Example 11: The computing system of example 9, wherein the processing circuitry executes the instructions to provide the effect trend to a computing device through a media content item feed that presents each media content item in the set of media content items in a sequence.
Example 12: The computing system of example 9, wherein the processing circuitry executes the instructions to: determine the set of media content items contains fewer than a threshold number of media content items; and responsive to determining the set of media content items contains fewer than the threshold number of media content items, refrain from providing the effect trend including the set of media content items.
Example 13: The computing system of example 9, wherein the one or more effects used in at least the seed media content item is a particular video effect and a particular audio effect.
Example 14: The computing system of example 9, wherein the one or more effects used in at least the seed media content item is a particular audio effect.
Example 15: The computing system of example 9, wherein to identify the seed media content item the processing circuitry executes the instructions to identify the seed media content item from a set of seed media content items and each seed media content item in the set of seed media content items includes the one or more effect attributes.
Example 16: The computing system of example 15, wherein the seed media content item has a higher inspiration metric compared to one or more other seed media content items from the set of seed media content items, the inspiration metric comprising one or more of a number of unique channels, a conversion rate, or lifetime views.
Example 17: Non-transitory computer-readable storage media includes instructions, that when executed by processing circuitry, cause the processing circuitry to identify, from a plurality of media content items, a seed media content item with one or more effect attributes indicating one or more effects used in at least the seed media content item; determine whether the seed media content item is associated with a creation attribute indicating one or more users created one or more other media content items including the one or more effects within a predefined period of time after the seed media content item was watched by the one or more users; responsive to determining the seed media content item is associated with the creation attribute, identify a set of media content items with the one or more effect attributes from the plurality of media content items; and output an indication of an effect trend including the set of media content items.
Example 18: The non-transitory computer-readable storage media of example 17, wherein each media content item in the set of media content items is associated with an embedding in an embedding space that is within a predetermined distance of an embedding of the seed media content item in the embedding space.
Example 19: The non-transitory computer-readable storage media of example 17, wherein the instructions, when executed by processing circuitry, cause the processing circuitry to provide the effect trend to a computing device through a media content item feed that presents each media content item in the set of media content items in a sequence.
Example 20: The non-transitory computer-readable storage media of example 17, wherein the instructions, when executed by processing circuitry, cause the processing circuitry to: determine the set of media content items contains fewer than a threshold number of media content items; and responsive to determining the set of media content items contains fewer than the threshold number of media content items, refrain from providing the effect trend including the set of media content items.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that may be accessed by one or more computers or one or more processors to retrieve instructions, code and/or data structures for implementation of the techniques described in this disclosure. A computer program product may include a computer-readable medium.

By way of example, and not limitation, such computer-readable storage media may comprise RAM, ROM, EEPROM, CD-ROM or other optical disk storage, magnetic disk storage, or other magnetic storage devices, flash memory, or any other storage medium that may be used to store desired program code in the form of instructions or data structures and that may be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while disks reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of intraoperative hardware units, including one or more processors as described above, in conjunction with suitable software and/or firmware.

It is to be recognized that, depending on the example, certain acts or events of any of the methods described herein may be performed in a different sequence, may be added, merged, or left out altogether (e.g., not all described acts or events are necessary for the practice of the method). Moreover, in certain embodiments, acts or events may be performed concurrently, e.g., through multi-threaded processing, interrupt processing, or multiple processors, rather than sequentially.

In some examples, a computer-readable storage medium comprises a non-transitory medium. The term “non-transitory” indicates that the storage medium is not embodied in a carrier wave or a propagated signal. In certain examples, a non-transitory storage medium may store data that can, over time, change (e.g., in RAM or cache).

Various examples have been described. These and other examples are within the scope of the following claims.

1. A method comprising:
identifying, by a computing system and from a plurality of media content items, a seed media content item with one or more effect attributes indicating one or more effects used in at least the seed media content item;
determining, by the computing system, whether the seed media content item is associated with a creation attribute indicating one or more users created one or more other media content items including the one or more effects within a predefined period of time after the seed media content item was watched by the one or more users;
responsive to determining the seed media content item is associated with the creation attribute, identifying, by the computing system, a set of media content items with the one or more effect attributes from the plurality of media content items; and
outputting, by the computing system, an indication of an effect trend including the set of media content items.

2. The method of claim 1, wherein each media content item in the set of media content items is associated with an embedding in an embedding space that is within a predetermined distance of an embedding of the seed media content item in the embedding space.

3. The method of claim 1, further comprising providing, by the computing system, the effect trend to a computing device through a media content item feed that presents each media content item in the set of media content items in a sequence.

4. The method of claim 1, further comprising:
determining, by the computing system, the set of media content items contains fewer than a threshold number of media content items; and
responsive to determining the set of media content items contains fewer than the threshold number of media content items, refraining, by the computing system, from providing the effect trend including the set of media content items.

5. The method of claim 1, wherein the one or more effects used in at least the seed media content item is a particular video effect and a particular audio effect.

6. The method of claim 1, wherein the one or more effects used in at least the seed media content item is a particular audio effect.

7. The method of claim 1, wherein identifying the seed media content item comprises identifying, by the computing system, the seed media content item from a set of seed media content items and each seed media content item in the set of seed media content items includes the one or more effect attributes.

8. The method of claim 7, wherein the seed media content item has a higher inspiration metric compared to one or more other seed media content items from the set of seed media content items, the inspiration metric comprising one or more of a number of unique channels, a conversion rate, or lifetime views.

9. A computing system comprising:
a memory that stores instructions; and
processing circuitry that executes the instructions to:
identify, from a plurality of media content items, a seed media content item with one or more effect attributes indicating one or more effects used in at least the seed media content item;
determine whether the seed media content item is associated with a creation attribute indicating one or more users created one or more other media content items including the one or more effects within a predefined period of time after the seed media content item was watched by the one or more users;
responsive to determining the seed media content item is associated with the creation attribute, identify a set of media content items with the one or more effect attributes from the plurality of media content items; and
output an indication of an effect trend including the set of media content items.

10. The computing system of claim 9, wherein each media content item in the set of media content items is associated with an embedding in an embedding space that is within a predetermined distance of an embedding of the seed media content item in the embedding space.

11. The computing system of claim 9, wherein the processing circuitry executes the instructions to provide the effect trend to a computing device through a media content item feed that presents each media content item in the set of media content items in a sequence.

12. The computing system of claim 9, wherein the processing circuitry executes the instructions to:
determine the set of media content items contains fewer than a threshold number of media content items; and
responsive to determining the set of media content items contains fewer than the threshold number of media content items, refrain from providing the effect trend including the set of media content items.

13. The computing system of claim 9, wherein the one or more effects used in at least the seed media content item is a particular video effect and a particular audio effect.

14. The computing system of claim 9, wherein the one or more effects used in at least the seed media content item is a particular audio effect.

15. The computing system of claim 9, wherein to identify the seed media content item the processing circuitry executes the instructions to identify the seed media content item from a set of seed media content items and each seed media content item in the set of seed media content items includes the one or more effect attributes.

16. The computing system of claim 15, wherein the seed media content item has a higher inspiration metric compared to one or more other seed media content items from the set of seed media content items, the inspiration metric comprising one or more of a number of unique channels, a conversion rate, or lifetime views.

17. Non-transitory computer-readable storage media comprising instructions, that when executed by processing circuitry, cause the processing circuitry to:
identify, from a plurality of media content items, a seed media content item with one or more effect attributes indicating one or more effects used in at least the seed media content item;
determine whether the seed media content item is associated with a creation attribute indicating one or more users created one or more other media content items including the one or more effects within a predefined period of time after the seed media content item was watched by the one or more users;
responsive to determining the seed media content item is associated with the creation attribute, identify a set of media content items with the one or more effect attributes from the plurality of media content items; and
output an indication of an effect trend including the set of media content items.

18. The non-transitory computer-readable storage media of claim 17, wherein each media content item in the set of media content items is associated with an embedding in an embedding space that is within a predetermined distance of an embedding of the seed media content item in the embedding space.

19. The non-transitory computer-readable storage media of claim 17, wherein the instructions, when executed by processing circuitry, cause the processing circuitry to provide the effect trend to a computing device through a media content item feed that presents each media content item in the set of media content items in a sequence.

20. The non-transitory computer-readable storage media of claim 17, wherein the instructions, when executed by processing circuitry, cause the processing circuitry to:
determine the set of media content items contains fewer than a threshold number of media content items; and
responsive to determining the set of media content items contains fewer than the threshold number of media content items, refrain from providing the effect trend including the set of media content items.
